(19) United States
(12) Patent Application Publication
(10) Pub. No.: US 2006/0001189 A1
(43) Pub. Date: Jan. 5, 2006

(54) Process and plant for paper and paperboard production starting from waste

(76) Inventor: Giuseppe Locati, Milano (IT)

Correspondence Address: Shlesinger, Fitzsimmons & Shlesinger, Suite 1323, 183 East Main Street, Rochester, NY, 14604, US

(21) Appl. No.: 10/171,220

(22) Filed: Aug. 14, 2002

Related U.S. Application Data
(63) Continuation-in-part of application No. 09/403,210, filed on Oct. 14, 1999, now abandoned.

(30) Foreign Application Priority Data
Apr. 18, 1997 (IT) MI97A000904
Aug. 4, 1998 (WO) PCT/EP98/02215

(51) Int. Cl. B27N 3/02

(52) U.S. Cl. 264/115; 264/140; 425/90; 425/406; 425/363

(57) ABSTRACT

Paperboard is produced by chopping or mincing waste paper the particles of which are fed through a mixer which can blend the particles with particles of different composition or color after which the particles are laid down into a uniform layer to form a mat which is sprayed with water. The entire mat is then subjected to a uniform compression from anywhere from between 300 to 500 kg/cm². Alternatively, at least two such layers of paper particles are separated by a water film and are then compressed into a mat so that the water is forced to the outside of the mat through the layers.

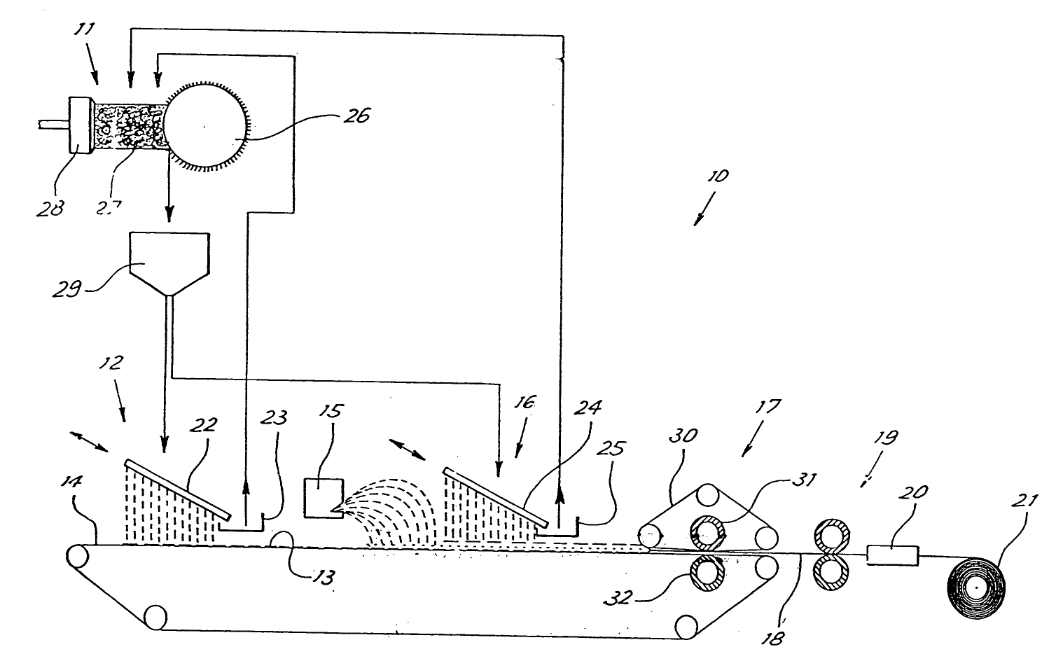

### RELATED APPLICATION

This application is a continuation-in-part of applicant's pending U.S. application Ser. No. 09/403,210 filed Oct. 4, 1999.

### BACKGROUND OF THE INVENTION

The present invention relates to a process and a plant for paper and paperboard production. IN particular, the invention relates to a continuous-flow production, with a minimum use of water and energy, starting from waste paper.

It is known that in paper production employment of great amounts of water is required. Usually, the process comprises a paper maceration step carried out in plenty of water, so as to separate the long natural fibers. These fibers are subsequently coupled with each other by drop and light compression between cloths and felts. Finally, the product thus obtained is submitted to a drying step. In addition to the high amount of water required, there is also a great waste of energy due both to the necessity of removing water from the product, and the necessity of a long treatment step of the polluted water thus produced. WO 95/12090 disclosed a process for producing a fibrous sheet material by means of dry-laying cellulosic fibers on a continuously moving support to form a layer thereon and wetting the layer sufficiently to cause hydrogen-bonds to be formed. However, the product obtained by this method needs further processing to be utilizable.

It is a general object of the present invention to obviate the above mentioned drawbacks by providing a process and a plant for paper production starting from waste paper, with a low water amount, preferably without production of impregnation water to be evacuated and a limited waste of energy.

### SUMMARY OF THE INVENTION

In view of this object, in accordance with the invention a process for paperboard production has been devised which comprises the steps of: chopping up waste paper to reduce it to particles; laying down particles into an even or uniform layer to form a mat; spraying the mat with water; and submitting the mat to a compression at least as strong as 200 kg/cm² and preferably included between 300 and 500 kg/cm².

In accordance with this process also provided is a plant for paper or paperboard production, comprising: means for chopping up waste paper until it is reduced to particles; first distribution means to lay down particles into an uniform layer to form a mat; spraying means for spraying the mat with water; and pressing means to submit the mat to a compression at least as strong as 200 kg/cm² and preferably included between 300 and 500 kg/cm². A further process for paper and paperboard production in accordance with the invention comprises the steps of forming a mat consisting of two layers of paper particles with a water film therebetween and compressing the mat to force water to the outside through the layers.

### THE DRAWINGS

The sole drawing is a schematic side elevational view of the apparatus employed for producing the paperboard.

### DETAILED DESCRIPTION OF THE PREFERRED EMBODIMENTS

For better explaining the innovatory principles of the present invention and the advantages it offers over the known art, a possible embodiment applying said principles will be given hereinafter by way of non-limiting example, with reference to the accompanying sole drawing.

With reference to the drawing, a plant 10 for paper production in accordance with the invention is diagrammatically shown. The plant is comprised of a device 11 for producing paper fragments or powder that are sent to a first distributor 12 to form a uniform layer 13 on a belt conveyor 14. Fragments can be advantageously reduced to average sizes not exceeding 7 mm and, preferably, comprises between 2 mm and 5 mm. A spraying device 15 wets, advantageously by shower atomization, the layer formed on the mat so as to produce a damp mat or ribbon. A second distributor 16 may be provided for distributing a second, like layer of paper fragments or powder on the first damp layer. Thus a mat or ribbon is obtained which is formed of two uniform layers of paper fragments with a water film between the two layers. The damp paper-fragment ribbon is passed into a pressing device 17 and is compressed thereby into a compact ribbon 18 of substantially uniform thickness. Pressing takes place at pressures at least as high as 200 kg/cm² and preferably, included between 300 and 500 kg/cm². Advantageously, the amount of water distributed over the fragment layer is selected in such a manner that the pressing thereof does not produce an important water extraction from the paper ribbon. For example, it has been found advantageous for the water amount to be lower than or equal to one litre per paper kg. By virtue of pressing the sprayed water which is between the layers is forced to penetrate at least partly into the layers and the paper ribbon dampness is thus substantially made uniform in the ribbon thickness. The outgoing ribbon is just slightly damp.

It has been noted that the paper ribbon thus obtained has an excellent cohesion, comparable with that obtained with paper produced following traditional methods, although made of paper fragments.

The ribbon thus obtained can be submitted to a further pressing operation by means of rollers 19, for providing a further surface finish, for example. If the residual retained water amount is considered still too much, the paper ribbon may be further submitted to a drying step 20. Once the paper production steps have been completed, paper can be wound onto a bobbin 21.

Distribution of paper fragments to form the two layers on the mat can be accomplished by means of inclined vibration screens 22, 24 having appropriate mesh sizes based on the desired fragment sizes. Possible fragments of bigger sizes can be gathered into containers 23, 24 at the lower screen end to be then recirculated and sent to the chopping device 11 again.

The chopping or mincing device 11 can be formed of a toothed rotary drum 26 against which the waste paper mass 27 is pushed by means of a press 28.

The minced paper particles can be assimilated to flocks; therefore they are quite different from cellulose fibres of greater or smaller length that are usually necessary in paper production according to the known art.

The paper particles before reaching distributors 12, 16 can also be mixed in a mixer 29 with other particles of different production. For instance, colour of the produced paper can be adjusted by missing particles produced from chopping of paper particles of different composition and source.

The paper ribbon pressing and squeezing device 17 can advantageously consist of the end portion of conveyor 14 and a rotary belt 30 dispoesd to have a stretch facing said end portion of the conveyor belt 14. Belts 14 and 30 are driven in movement at the same speed and the faced belt stretches are pressed against each other by pressing rollers 31, 32 disposed face-to-face on opposite belt faces.

The belt material is such selected as to be pervious to water or in any case capable of enabling removal of water from the ribbon which is squeezed between the belts. At this point it is apparent that the intended purposes have been reached.

Water supply can be of the strictly necessary amount for a correct damping of layers. Pressing causes the water to pass through the layers from inside to outside reaching a perfect layer permeation. The residual dampness is very low and, should it be necessary, can be easily removed by quick drying with a low energy consumption. By adjusting the spray water amount, there is practically no water to be drawn.

Thus, high water consumption does not exist and water purification operations which are peculiar to the known are not required.

The plant in accordance with the invention is very simple and manufacture and servicing of same is easy and cheap. Production of two or more layers enables manufacture of paper and paperboard having different surface features on the two faces to be carried out. A process in accordance with the invention is adapted to make simple or two-faced paper or paperboards consisting either of a single uniform layer or of superposed uniform layers.

Thickness of the produced layers can be easily varied and checked by masking the perforated surfaces of the vibration screens, for example.

Unlike the known art, the plant can be easily and readily stopped and re-started, in order to comply, for instance, with work shifts, ordinary and extraordinary maintenance requirements, production controls or changes, etc. Obviously, the above description of tan embodiment applying the innovatory principles of the present invention is reproduced by way of example only and cannot be considered as a limitation of the inventive scope as herein claimed. For example should it be necessary, additives may be added to the atomized water for meeting particular requirements, the additive amounts being substantially those that are strictly necessary for the produced amount of paper, without wastes and without recovery being required. A small amount of glue or paste can be optionally added to water. For instance, it has been found that with more than 20% of glue in the water a nearly coated thin paperboard can be obtained.

1. A process for producing paper or paperboard from waste paper comprising the steps of:
chopping up waste paper to reduce the paper to particles;
laying down said particles into a uniform layer to form a mat;
thereafter spraying the mat with water; and
submitting the entire mat uniformly to a compression at least as strong as 200 kg/cm² and up to and including 500 kg/cm² to form a ribbon of paper the dampness of which is substantially uniform throughout the thickness thereof

2. A process as claimed in claim 1, comprising the further step of laying down a second particle layer on the first-named layer after the spraying step and before the pressing step.

3. A process as claimed in claim 1, characterized in that spraying is carried out by shower atomization.

4. A process as claimed in claim 1, characterized in that said compression of said mat is carried out by pressing rollers while the mat is being passed between a pair of confronting conveyor belts.

5. A process as claimed in claim 1, comprising a further compression step performed on said mat downstream of the first-named compression step.

6. A process as claimed in claim 1, comprising the further step of decreasing the water content in the mat by heating.

7. A process as claimed in claim 1, including controlling the spraying of water so that substantially no water is drawn from the mat during the compression thereof

8. A process as claimed in claim 1, in which water supplied by spraying the mat is lower than or almost equal to one litre per paper kg. of particles.

9. A process as claimed in claim 1, in which particles have an average size not exceeding 7 mm and, preferably, including between 2 mm and 5 mm.

10. A plant for producing paper or paperboard from waste paper, comprising,
means (11) for chopping up waste paper; until the paper is reduced to particles;
first distribution means (12) to lay down particles into a uniform layer to form a particle mat;
spraying means (15) for spraying the mat with water; and
pressing means (17) for forming said mat into a ribbon of paper by submitting the entire mat uniformly to a compression at least as strong as 200 kg/cm² and up to and including 500 kg/cm².

11. A plant as claimed in claim 10, characterized in that it comprises second distribution means (16) to lay down a second particle layer on the first layer, which means is disposed between the spraying means (15) and the pressing means (17).

12. A plant as claimed in claim 10, characterized in that the spraying means (15) carries out shower atomization onto the layer.

13. A plant as claimed in claim 10, characterized in that the pressing means (17) comprises facing pressing rollers (31, 32) between faced stretches of conveyor belts (14, 30) between which the particle mat runs.

14. A plant as claimed in claim 10, characterized in that the particle mat is formed on a conveyor belt (14) passing close to the different distribution, spraying and pressing means.

15. A plant as claimed in claim 10, characterized in that the plant comprises further mat pressing means (19) disposed downstream of the first-named pressing means.

16. A plant as claimed in claim 10, characterized in that the plant comprises drying means (20) to decrease the water content in the mat downstream of the pressing means.

17. A plant as claimed in claim 11, characterized in that the distribution means (12, 16) comprises vibration screens (22, 24).

18. A plant as claimed in claim 10, characterized in that the waste paper chopping means (11) comprises a toothed rotary drum (26) against which the waste paper mass (27) is forced.

19. A plant as claimed in claim 10, characterized in that at the outlet of the paper chopping means (11), particles have an average size not exceeding 7 mm and including between 2 mm and 5 mm.

20. A process according to claim 1, including laying down said particles into two even layers of said particles of chopped waste paper, spraying said water to produce a water film between said two layers, and causing the compression to force the water film through the layers to the outer surfaces thereof
